(19) United States
(12) Patent Application Publication
(10) Pub. No.: US 2009/0277719 A1
(43) Pub. Date: Nov. 12, 2009

(54) System for lowering objects and people

(75) Inventor: Anthony Clough, Kensington Gore (GB)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Royal College of Art, London (GB)

(21) Appl. No.: 11/921,927

(22) PCT Filed: Jun. 22, 2006
(86) PCT No.: PCT/GB2006/002266

§ 371 Date: Jul. 16, 2008

(30) Foreign Application Priority Data
Jun. 22, 2005 (EP) 05253888.1

(51) Int. Cl. A62B 35/04; E06C 7/18

(52) U.S. Cl. 182/5; 182/3

(57) ABSTRACT

The present invention provides a device for lowering a weight from a structure, the device comprising: a first elongate element (10) that is secured via a fixing (16) to a stable structure, for example the structure from which a weight is to be lowered; a second elongate member (12) that extends parallel to the first member (10) and is joined thereto by a series of equally-spaced links or links (14), thereby giving the appearance of a ladder. A weight to be lowered is secured to the top of the second member (12) by a connection, which could be a clamp onto which a harness is secured; alternatively, the harness could be made integral with the second elongate member (12). The links (14) are made of a ductile polymer material and the links successively stretch and fail, thereby lowering the weight controllably. The invention also finds application as an energy absorbing element, which uses the same method to safely control and cease a motion, such as a person's fall.

### TECHNICAL FIELD

The present application relates to a system of lowering objects and is especially concerned with lowering people and objects safely from a height.

The present application finds application in many fields, including for example:
as an escape from a fire or hazard in a building;
as a safety feature for people operating at heights, for example window cleaners, tree surgeons, builders and overhead line maintenance engineers;
as an arrangement for moving heavy objects, for example furniture (the device of the present invention can be the primary method for lowering the object or can be used a back up);
as a safety device in climbing and mountaineering and to rescue people who find themselves at a height, for example on a rock face, a tree or bridge;
for the lowering of personnel from helicopters, which finds particular application in the rapid discharge of military personnel from helicopters;
for the lowering of objects from helicopters, e.g. the lowering of aid from helicopters in locations where it is dangerous to land and/or where the terrain precludes the helicopter from landing;
in the leisure industry to provide a “thrill” experience of being lowered from a height in a way similar to bungee jumping and abseiling.
to absorb energy in a moving object or person to reduce their speed, or to safely limit a fall, acting as what is known in “work at height” terms as an energy absorbing lanyard.

### BACKGROUND ART

Mechanisms are known for lowering objects from a height and these include ropes and a simple block and tackle; friction arrangements are also known for engaging a rope to slow the descent of an object or a person. However, rope itself is quite heavy and bulky and the additional devices to control the descent of an object or person merely add to the bulk and the weight.

Another form of escape that can be used to descend from a height is a rope ladder, which can be deployed to descend from a window in the event of fire; despite their ability to be rolled up, rope ladders are bulky and heavy. They are also hazardous since it is easy to fall from a rope ladder.

Rope-based solutions for lowering people from heights including rope ladders, all suffer from the requirement that the person concerned must either be relatively agile himself/herself or have someone else to help them who is fit. Also, it is often required that the user needs a certain degree of knowledge of the operation of such rope-based solutions and the necessary skill to operate them. Furthermore, ropes have a finite life and must be replaced periodically and the replacement date must be logged to ensure that an old rope is replaced at the appropriate time.

There is a need for a safety device that can be made light and compact and that can be used easily.

EP 0 496 028 describes a fall arresting device having two ends, one of which is secured to an anchoring point and the other to a person. The two ends are connected by a chain that is doubled back on itself to form a U-shape. The two limbs of the U-shaped chain are joined together by short lengths of stainless steel cable. If a person should fall, tension is applied between the two ends of the chain, which causes lengths of cable to snap in succession until their fall is arrested. The device is heavy, bulky and cumbersome.

EP-1 308 398 discloses a packaging device for holding bottles that is in the form of a plastic sheet having a row of openings for receiving the bottles and a handle for carrying the package.

### DISCLOSURE OF THE INVENTION

According to the present invention, there is provided a device for lowering a weight from a structure, the device comprising:
a first elongate member having an anchoring end that includes means configured to attach the anchoring end to the structure;
a second elongate member extending alongside the first elongate member and having a weight-support end that includes means configured to support the weight,
a plurality of links connecting the first and the second elongate members together, the links being spaced-apart along the length of the first and the second members and being made of a polymer material that can successively stretch and fail when the weight is supported by the said support end of the second member and the said anchor end of the first elongate member is attached to the structure,
   wherein the anchoring end of the first elongate member is provided at the same end of the device as the weight support end of the second elongate member.

The device may also be used for removing kinetic energy from a moving person or object, e.g. to bring it to a halt, and as such the device can be used not only to control downward movement but also to control movement in other directions, e.g. for braking a horizontally-moving object.

The device itself will generally be elongated in shape and the anchoring end for securing the first elongate member to the structure will be provided at the same end of the device as the weight support end of the second elongate member since only then will the links connecting the first and second elongate members together be subject to the gravitational forces of the weight being lowered. The gravitational force is absorbed, according to the present invention, by the stretching and failing of the successive links joining the first and second elongate members together. This allows the weight to be lowered slowly and in a controlled manner.

It is preferred that the first and second elongate members and the links are integral with each other. Preferably, the elongate members and the links are formed from a single sheet of polymer material.

It is preferred that the links are spaced apart by a distance such that one link begins to take the load of the weight as the preceding link fails. In this way, the weight is supported between a pair of the first and second members by only one link, or at most two links, at a time and this provides for a smooth descent. The arrangement in which one link fails before the succeeding link starts to bear the weight is preferably avoided since that will lead to a jerky descent and the weight will be in free fall, albeit only for a very short period of time, before the next succeeding link takes up the weight. The absorption of the momentum gained during free fall could place unacceptable stresses on the device. In addition, such an arrangement is inefficient in its absorption of energy and leads to a faster descent speed.

The polymer materials from which the links can be formed are all ductile and preferably have an elongation at break of at least 100%, more preferably 200 to 500%.

The actual dimensions of the links, and in particular the cross sectional area of the links, will dictate the weight that can be lowered using the device of the present application. The length of the links will depend on the spacing between the links so that the above successive stretching and failing mechanism can be provided.

In order to provide optimum plastic elongation of the links, the polymer material is preferably a semi-crystalline thermoplastic that is branch-free. Possible materials include ETFE (a copolymer of ethylene and tetrafluoroethylene) and LDPE (low density polyethylene). Typical tensile strengths of these materials (MPa) under standard conditions are as follows:

| | |
|---|---|
| ETFE | 49 |
| LDPE | 14 |

The preferred material when the device is used as a fire escape is a fluoropolymer, such as ETFE, which has high temperature stability, self-extinguishing fire properties, high resistance to ultraviolet radiation degradation and chemical attack as well as good surface properties, low friction and are non-adherent so that, if folded away in a pack, the device can readily be taken out without the folds of the device adhering to each other. However, where fire-resistant properties are not needed, and protection from sources of ultraviolet radiation can be provided, other polymers, e.g. LDPE, are preferred on the ground of cost.

The polymer is preferably chosen such that it is not subjected to substantial strain hardening, which is an increase in the tensile properties of the polymer when subject to strain, since strain hardening can prevent the fracture of the links, thereby halting the descent of the weight. Some strain hardening is to be expected in the polymer materials but is usually balanced by a reduction in the cross-sectional area of the link as it is stretched (so-called “necking”) and so the effects cancel each other out, and so a certain amount of strain hardening is acceptable. In material mechanics terms the ideal is for the polymer to exhibit “purely plastic” behaviour.

ETFE is the preferred material because of its low strain-hardening properties, high elongation and strength, as well as the properties mentioned above possessed by fluoropolymers. However, other materials, for example LDPE, are also acceptable, although it does not have the advantageous properties of fluoropolymers discussed above and has a lower tensile strength than ETFE. On the other hand, LDPE is substantially cheaper than ETFE and has a lesser environmental impact, so is likely to be selected for most commercial applications.

### BRIEF DESCRIPTION OF DRAWINGS

By way of example only, there will now be described a device in accordance with the present invention, with reference to the following drawings in which:

FIGS. 1 to 3 shows sequential steps in the use of the device in accordance with the present invention to lower a weight from a height;

FIG. 4 is a graph showing the strain of the device of FIG. 1 with varying levels of instantaneous or apparent stress, which is applied by applying different weights to the device of FIGS. 1 to 3; the graph also shows the velocity at which the weights descend, at various stress levels;

FIG. 5 is a graph showing the velocity of descent of a weight using the device of FIGS. 1 to 3 against the distance by which the weight falls;

FIG. 6 is a perspective view of a composite having two devices in accordance with the present invention;

FIG. 7 shows a section of the device of FIG. 6 that is used to select the number of devices that are used to lower a weight, in accordance the mass of the weight being lowered;

FIGS. 8 to 11 show the operation of the device of FIG. 7 when used to lower a relatively light weight;

FIGS. 12 to 14 show the operation of the device of FIG. 7 when used to lower a relatively heavy weight;

FIG. 15 shows a harness for use in accordance with the device of FIGS. 1 to 14;

FIG. 16 shows a release mechanism for use with the device depicted in the above Figures; and

FIG. 17 shows a device in accordance with the present invention.

### DESCRIPTION OF BEST MODE FOR PUTTING THE INVENTION INTO OPERATION

Referring initially to FIGS. 1 to 3, there is shown a descent device in accordance with the present invention. As can be seen from FIG. 1, the descent device includes a first elongate element 10 that is secured via a fixing 16 to a stable structure, for example the structure from which a weight is to be lowered. A second elongate member 12 extends parallel to the first member 10 and is joined thereto by a series of equally-spaced links or straps 14. Thus, the descent device has a ladder-like appearance. A weight to be lowered is secured to the top of the second member 12 by a connection 18, which could be a friction locking plate such as a buckle onto which a harness is secured; alternatively, the harness could be made integral with the second elongate member 12, as described below.

The fixing 16 for connecting the first elongate member 10 to the structure may be a clamp, although the fixing 16 and the connection 18 on the first and second elongate members 10,12 are preferably identical to each other except when an integral harness is provided.

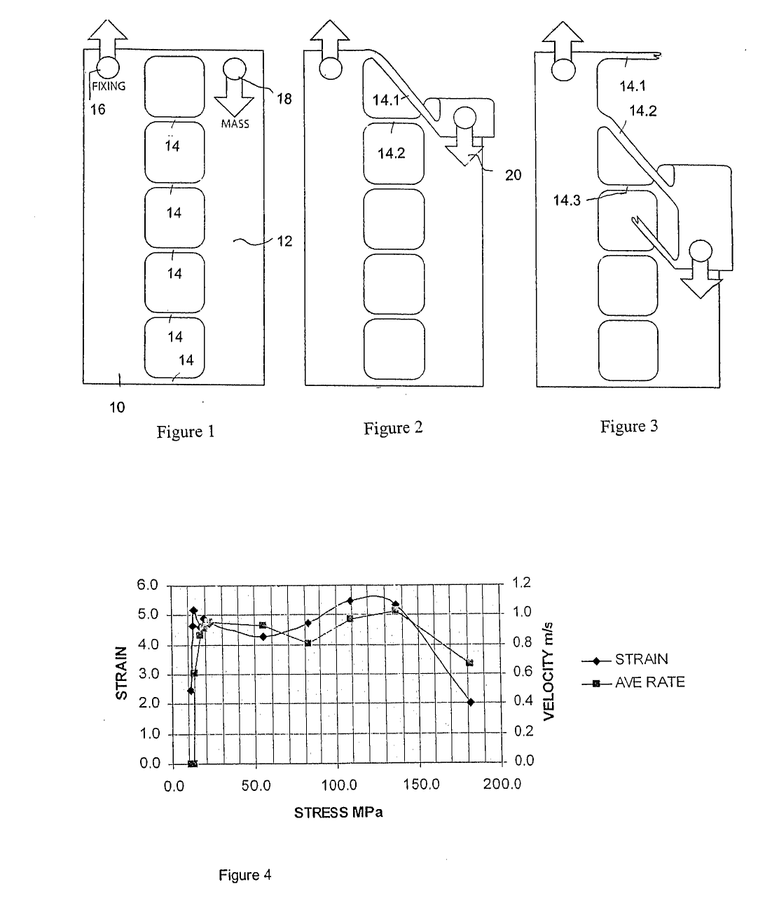

FIG. 2 shows the arrangement once the weight (indicated by the arrow 20) is released. The weight causes the first link 14.1 to stretch under the load 20. The first link 14.1 has a tensile strength that is less than that necessary to support the weight and so it stretches; since the force exerted by the weight exceeds the ultimate tensile strength of the link 14.1 it eventually fails. The load of the weight then transfers to the second link 14.2, which again is stretched, necks and fails. This process is repeated for subsequent links. The stretching process absorbs energy and so allows a steady descent. The configuration of the descent device is preferably such that a new link starts to be engaged as the previous link fails so that the descent of the weight is relatively smooth. The last link preferably has a much higher tensile strength than the earlier links, e.g. has a larger width, and so can support the weight without breaking so that, if the drop is longer than the length of the descent device when fully deployed, the weight does not plummet to the ground. In this way, the device can either lower a weight to the ground or arrest its fall before it reaches the ground.

Typical dimensions for a descent device made of LDPE are as follows:

| | | |
|---|---|---|
| Width of elongate elements 10, 12 | 55 | mm |
| Thickness of elongate elements 10, 12 | 0.5 | mm |
| Width of links 14 | 8 | mm |
| Length of links 14 | 40 | mm |

Since ETFE has a higher tensile strength than LDPE, it can support larger weights and/or have smaller dimensions to those set out above.

It has been found that a ratio of the distance between adjacent links to the length of the links of approximately 2:1 gives good results.

A number of descent devices as set out in FIGS. 1 to 3 made of LDPE were tested with different weights and the results are shown in FIG. 4, in which the strain of the device shown on the left-hand Y axis of FIG. 4 is the elongation at break divided by the original length of the link and the instantaneous or apparent stress shown on the X axis is the force exerted by the weight 18 divided by the cross sectional area of a link 14 before stretching. The terms “Instantaneous Stress” or “Apparent Stress” are used since the system is not in a steady state.

In addition, the velocity at which the weight descended was measured and is also shown in FIG. 4.

As can be seen from FIG. 4, the strain and speed of velocity remain reasonably constant in the range of loadings from 20 to 140 MPa. This is surprising and shows that it is possible to provide an even speed of descent even with a wide range of weights.

It was noted that, when high stresses were imposed on the descent device, the polymer appeared “crazed” showing alternate areas of relatively high stretching and relatively low stretching, accompanied by severe necking in several places. This multiple necking and stretching means that the material absorbed more energy than would be the case if it had stretched and necked at one location only.

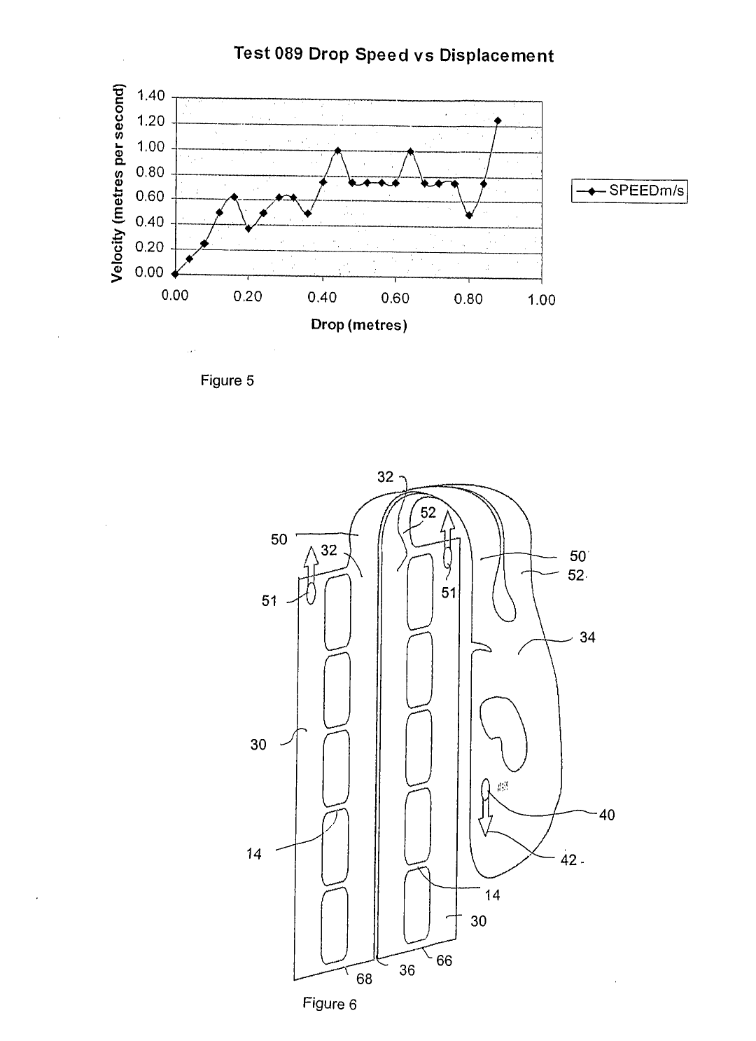

Turning now to FIG. 5, this shows the velocity at which the weight descends against the distance traveled using a descent device of FIG. 1 made of LDPE. This was measured by filming the descent of the weight using a moving picture camera having a constant frame speed. Successive frames were analysed to derive the velocity at various drop distances. The results are shown in FIG. 5. It should be noted that, over the first 0.4 metres, the weight accelerated (subject to several fluctuations) to a velocity of about 0.8 metres per second and thereafter continued at a descent rate of approximately 0.7 metres per second until the drop distance was 0.8 metres at which point the last link had failed and the weight dropped under gravity. Accordingly, it can be seen that a steady rate of descent can be achieved using the descent device of the present invention.

A series of tests have shown that the descent device can be used to lower weights under a stress range of 17 to 45 MPa using a tape of LDPE, which corresponds to a stress range of 34 to 90 MPa in ETFE. The weight that can be supported will depend on the geometry of the device and in particular the width and thickness of the links 14.

If it is desired to provide a broader range of weights that can be lowered, it is possible to combine two or more descent devices 66, 68 as shown in FIG. 6. In the descent device of FIG. 6, the tops of the outer elongated elements 30 of the two descent devices are anchored to a structure, as described in connection with FIGS. 1 to 3. The central elongated elements 32 of the two descent devices 66, 68 are connected by a yoke 34 but otherwise remain unconnected to each other along the extent of the inner elongate elements 32 since there is a gap 36 between them. It is not necessary to provide a gap 36 and indeed the two internal elongate elements 32 may be joined but if they are, the strength of the joint between them should be relatively low as compared to the strength of the links 14 joining each internal elongate member 32 to its corresponding outer elongate member 30.

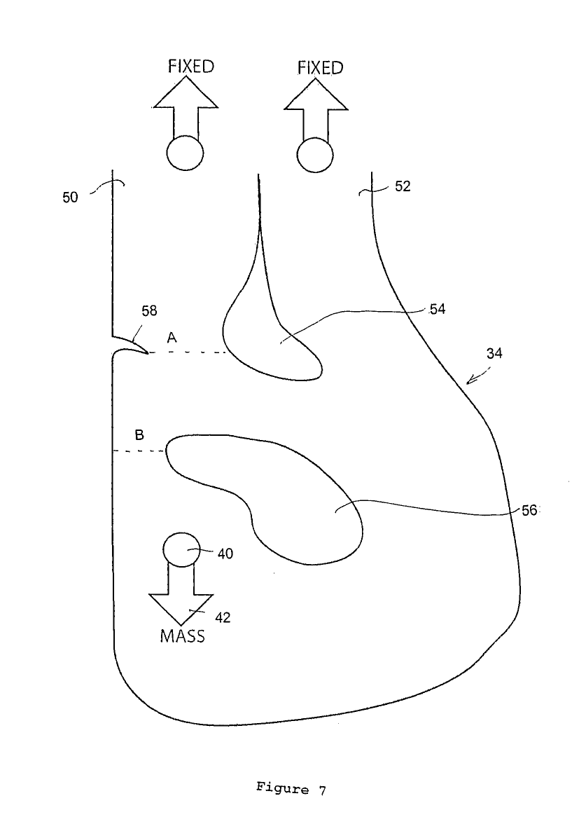

The weight is supported by the yoke 34 at position 40, as indicated by the arrow 42. The yoke 34 can select whether one set of links 14 is used to control the descent or whether both sets of links 14 are used. The operation of the yoke 34 is described below in connection with FIGS. 7 to 14.

Referring to FIG. 7, the yoke includes two tapes 50, 52 which are respectively connected to the two inner elongate members 32 (see FIG. 6). As described above, the tapes 50 and 52 are either not connected to each other or, if they are connected, the connection is relatively weak. Two voids 54, 56 are provided in the yoke 34, void 54 being an extension of the gap 36 between the two inner elongate members 32. A notch 56 is provided opposite the first void 54 on the side of the yoke to which the weight is applied through connector 40, as indicated by arrow 42.

The yoke is designed to have two points at which it can fail, indicated by line “A” and line “B” in FIG. 7. The mode of failure along line “A” is the propagation of a crack nucleated by the notch 58. The crack gradually propagates along the line “A” but the extension of the crack takes place over a period of time. Fracture along line “B” takes place by the material in the region of line “B” stretching and necking; in other words if the weight applied exerts a force that is greater than the ultimate tensile strength (UTS) of the yoke along line “B”, the yoke will give way along line “B” but if the force is less than the UTS, the yoke will not fail along line “B”. Fracture along line B is relatively rapid if the force indicated by arrow 42 is sufficiently large, and it will be faster than the propagation of the crack along line “A”.

FIGS. 8 to 11 show the operation of the yoke when a relatively a small force 42 is applied, for example a force greater than that exerted by the weight of a child weighing of the order of 13 kg. The force 42 is insufficient to burst the yoke along fracture line “B”. The mass is supported from point 40, which is on the same side of the yoke as the tape 50, and therefore the mass is suspended from the tape 50 and practically none of the load is taken by tape 52. The tension applied to the yoke between point 40 and the tape 50 is shown by solid line 60 in FIG. 8.

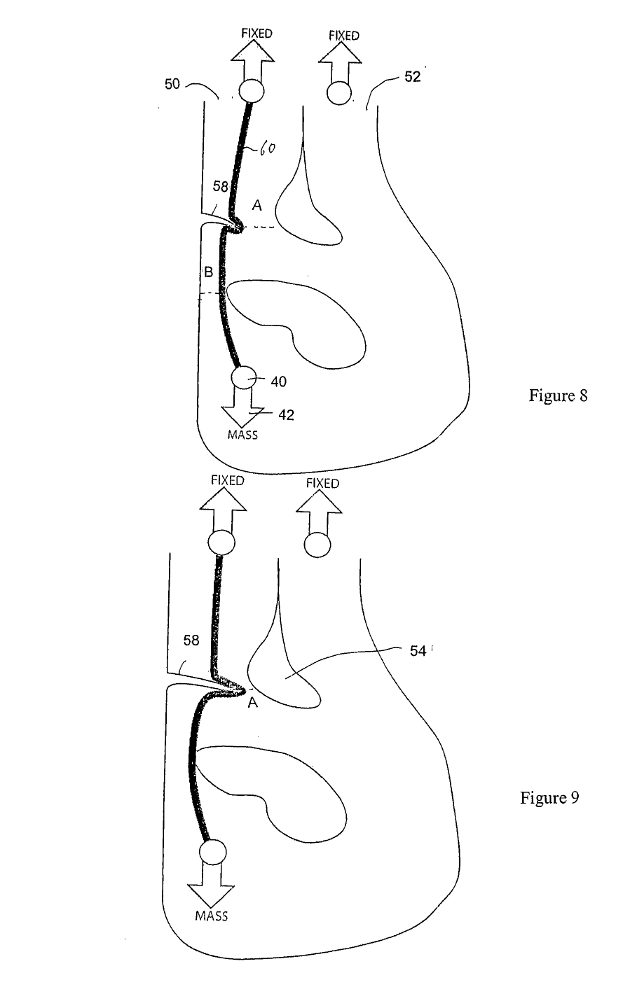

As indicated above, the mass 42 is insufficient to cause failure along line “B”. However, it can propagate the crack nucleated by notch 58 and this proceeds (see FIG. 9) slowly along line “A” until the crack reaches the void 54.

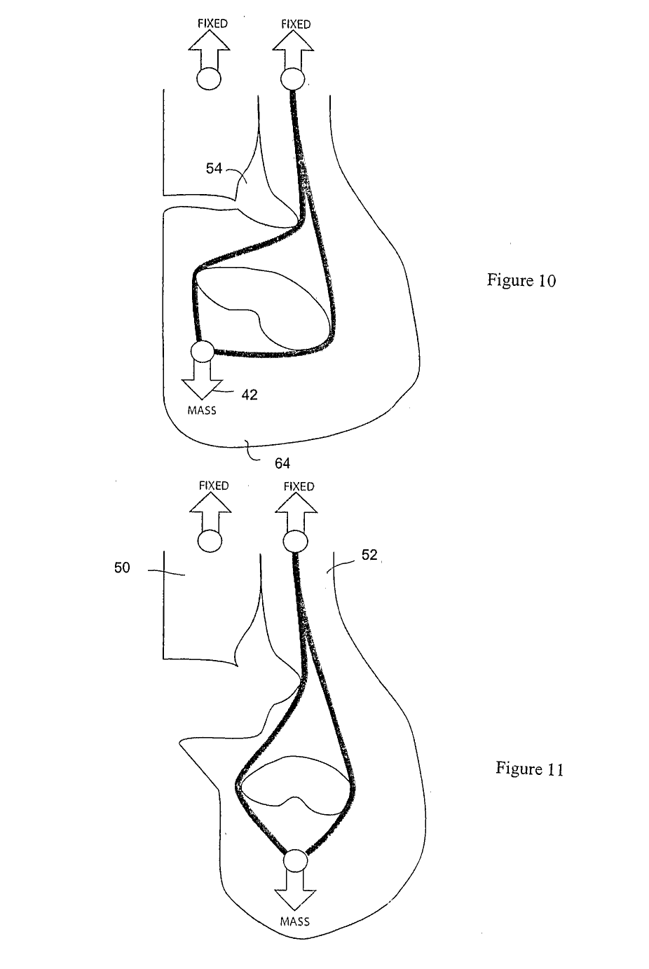

FIG. 10 shows the position once the crack has propagated all the way along line “A” to void 54. In these circumstances, the bottom section 64 of the yoke 34 swings anti-clockwise under the influence of the force 42 until it adopts the configuration shown in FIG. 11 where the weight is supported solely by tape 52. The weight is then able to descend using only one of the descent devices (i.e. the right hand device 66 (see FIG. 6)). Because of the gap 36 between the left-hand side descent device 68 and the right-hand descent device 66, the left hand side descent device 68 is not brought into operation in controlling the descent of the weight.

FIGS. 12 to 14 show the corresponding situation in which the force 42 exceeds the UTS threshold of the yoke along line “B” and so the yoke breaks along line “B”. FIG. 12 corresponds to FIG. 8 and shows the situation in which the force 42 resulting from the support of the weight from point 40 is first applied. Accordingly, further discussion of FIG. 12 is unnecessary.

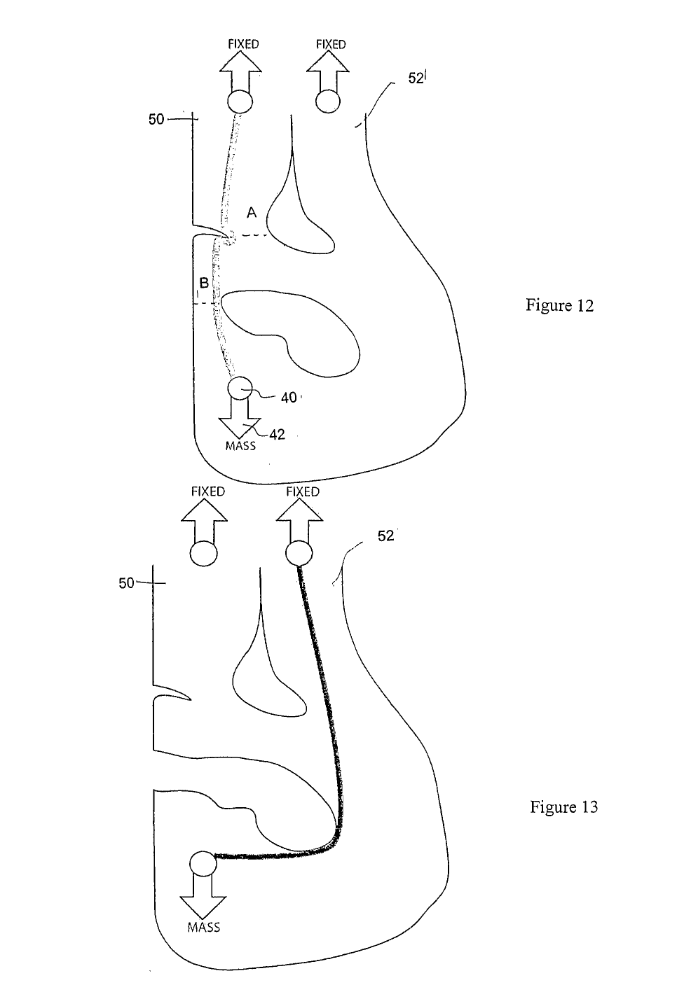

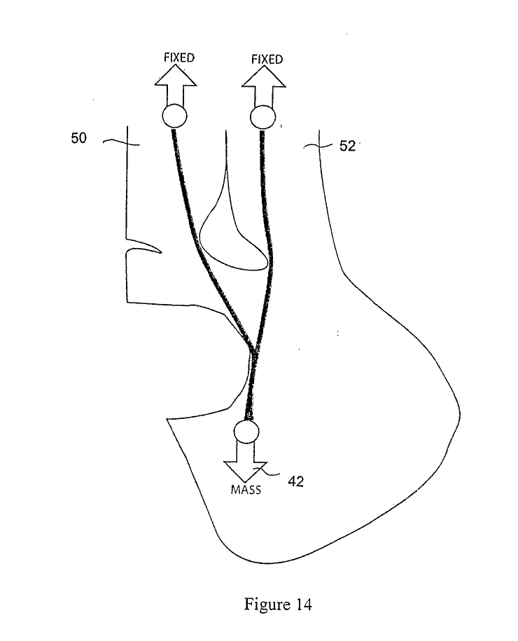

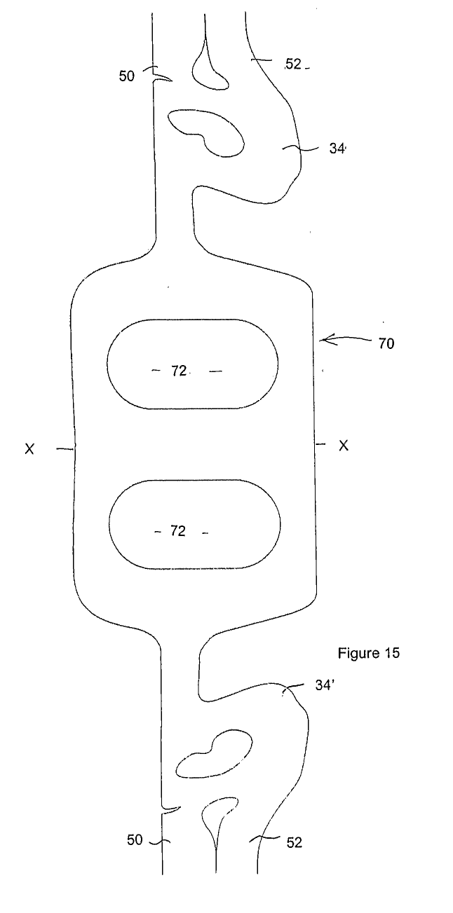

As indicated above, the force 42 is greater than that required to bring about a fracture along line “B” which occurs relatively quickly as compared to the propagation of the crack along line “A”. Accordingly, the yoke fails along line “B” before the crack manages to nucleate along line “A”. FIG. 13 shows the situation immediately following the failure along line “B”. Because the force 42 is exerted along one side of the yoke 34, as seen in FIG. 13, the weight drops and swings anticlockwise until it adopts the configuration shown in FIG. 14. In this case, the weight is supported practically equally by both of tapes 50 and 52 and this reduces the stress applied in the region of line “A” and any crack along line “A” will not propagate any further. In other words, the yoke fails only along line “B”.

Tapes 50 and 52 are connected directly to, or are integral with, the inner elongate members 32 of the two descent devices 66, 68 and so both descent devices are engaged to control the decent of the weight. Because both descent devices 66, 68 are used, a greater weight can be supported and controlled in its descent as compared to the use of a single descent device 66 consisting of only one pair of elongate members.

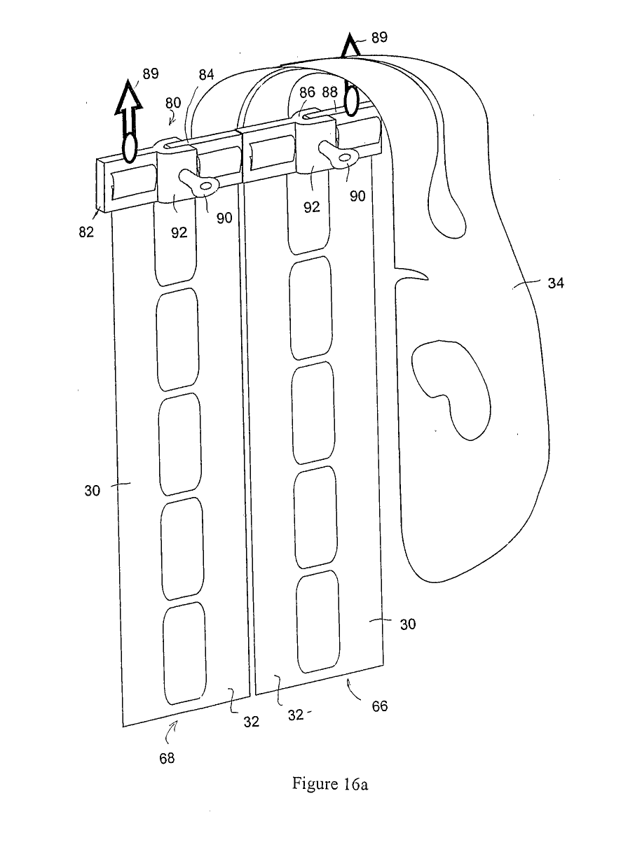

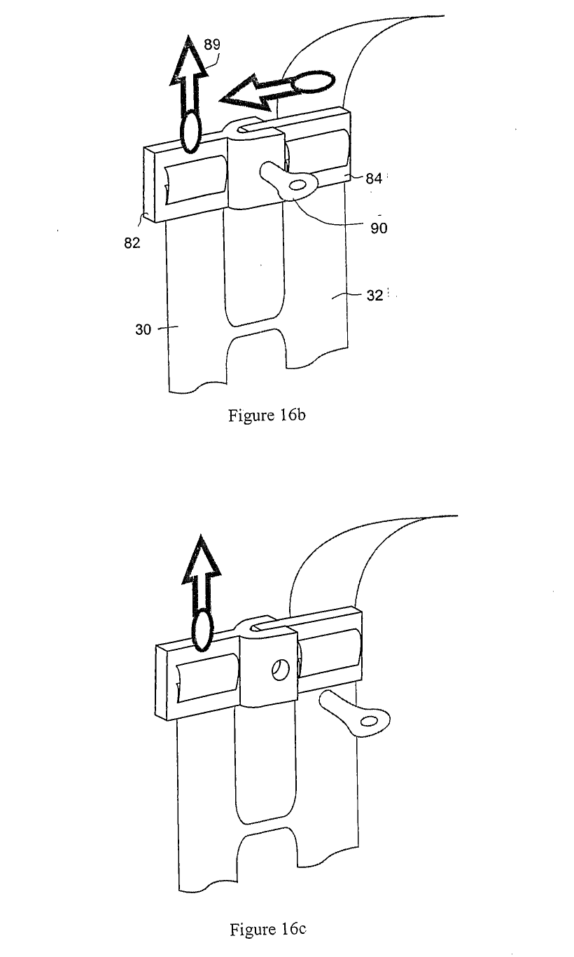

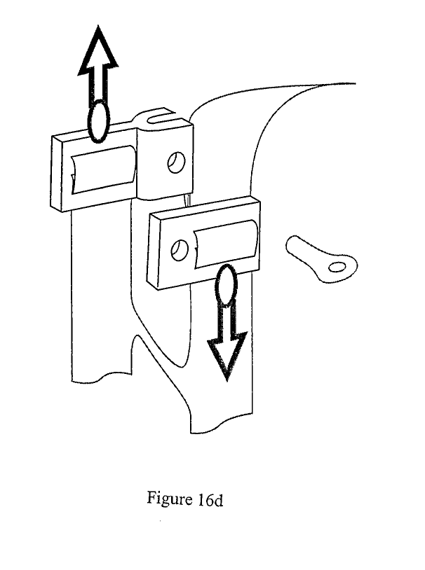

The control system provided by the yoke 34 can only operate correctly when there is a load being carried through it. If the weight were applied simultaneously to the yoke and the descent devices 66, 68, then the links 14 of the descent devices would begin to fail before the control system of the yoke could operate to select the correct number of descent devices to use to lower the weight applied. To accommodate this, a release mechanism 80 may be used (see FIG. 16), designed to hold the yoke 34 directly and allow the weight from the harness 70 to be applied initially only to the yoke 34, i.e. the weight is not applied in the first instance to the descent devices 66,68.

Referring to FIG. 16, the release mechanism 80 has a bar made up of four sections 82,84,86,88 that are each attached to a different one of the outer and the central elongated members 30,32 of the two descent devices 66,68. The outer bar sections 82, 88 are anchored to a structure (not shown), as indicated by arrows 89, and are each connected to one of the central bar sections 84,86 by means of a pin 90 extending through a forked junction 92 between the sections. The two central bar sections 84,86 are not connected to each other. The pins 90 can be removed once the yoke has selected the number of devices 66,68 to be deployed and the pins, when removed, allow the inner elongate member(s) 32 of each deployed device to lower a person or weight. If only one of the devices 66,68 is deployed, which will be device 66 with the yoke 34 described above, then it does not matter whether only the pin 90 of the device 66 is removed or whether both the pins 90 are removed but if both devices 66,68 are deployed, then both pins 90 should be removed. Accordingly it is better always to remove both pins and the pins could be connected together so that they are always removed simultaneously.

FIG. 16b to 16d show the sequence of events when the yoke 34 deploys both devices 66,68 and; although only bar parts 82,84 are shown, the sequence of events is the same for bar parts 86,88. FIG. 16b shows the situation before the pin 90 is removed; in FIG. 16c, the pin 90 has been removed and the bar parts 82,84 are released from each other, allowing the weight attached to the inner elongate member 32 to descend as a result of the stretching and failing of the links 14 joining the inner and outer elongate members (see FIG. 16d).

The use of the mechanism 80 offers advantages to users as they can position themselves on a window sill without it being possible to descend until they are ready to initiate descent by removing the pins 90. It therefore allows the user to become fully supported by the harness, to avoid sudden movements.

Many alternative arrangements for holding the devices 66,68 while the yoke 34 selects the number of devices that are to be deployed are of course possible.

Using the control arrangement in the yoke 34 depicted in connection with FIGS. 6 to 14, it is possible to provide controlled descent for the following two ranges of weights, which are given by way of example only:

35 to 92 kg: only one of the two descent devices 66, 68 is engaged;
57 to 149 kg: both descent devices 66, 68 are engaged.

Two systems shown in FIG. 6 can be used simultaneously so that there are four sets of links 14 to stretch and break to control the lowering of a weight. Such an arrangement is shown in FIG. 15, which also includes a harness 70 that is integral with two yokes 34,34′ which it turn are connected with two pairs of tapes 50,52. In use, the arrangement of FIG. 15 is folded along line X-X so that the upper and lower sections overlie each other. The harness is a simple hoop, including two openings 72 that in the folded arrangement overlie one another. A user slips the opening over his/her head and arms so that he/she is held under the shoulders. Under the user's weight, the harness 70 pulls in to the user for security. The harness is reasonably comfortable as the material yields and extends where it is in contact with the user's body to spread the load. The yoke control system 34 and the harness 70 can be cut from the same sheet as the lowering mechanism.

The two yokes 34, 34′ in the arrangement of FIG. 15 operate in parallel and it is possible to make them have different fracture strengths along lines “B”. Using this arrangement, it is possible to provide three ranges of load that can be distinguished by the yoke control mechanisms 34, 34′ as described above. This is enough to fully accommodate any user from 13-150 kg using the same arrangement, as follows:

Light weight, e.g. 13-35 kg. The weight is insufficient to fracture either yoke 34, 34′ along the line “B” but they both break along the line “A”. Thus only one of the descent devices (descent device 66) of each yoke is engaged in lowering the weight (i.e. two descent devices 66 are used in total).
Medium weight, e.g. 35-92 kg. The weight is sufficient to fracture one of the yokes 34 along the line “B” but not the second yoke 34′, which then breaks along the line “A”. Thus, both descent devices 66, 68 connected to the first yoke 34 are engaged in lowering the weight. However, only one descent device 66 connected to the second yoke 34′ is engaged in lowering the weight (i.e. three descent devices 66, 68 are used in total).
Heavy weight, e.g. 57-149 kg. The weight is sufficient to fracture both yokes 34, 34′ along the line “B”. Thus both descent devices 66, 68 of each of the two yokes 34, 34′ are engaged in lowering the weight (i.e. four sets of descent devices are used in total).

In summary, the present invention provides a device that is able to lower weights in a broad range from a structure in a controlled manner and the device itself can be made light, compact and easy to operate.

As is clear from the above description, the present invention is not limited to lowering people or objects to the ground and finds application as a safety device for people operating at heights for example window cleaners, tree surgeons, builders and overhead line maintenance engineers and also climbers and mountaineers. Thus the device of the present invention can act as a safety device to arrest a fall; in the course of the arrest of a fall, the weight will be lowered but generally not to the ground. If it is desired to arrest the fall in a relatively short distance, some (but not necessarily all) of the links will fail. In this case, the shorter the distance that the person should be allowed to fall, the higher the tensile strength of the links should be. The fall arrester device may, for example be configured to break the fall of an 80 kg person over a distance not exceeding 2 metres when the device supports the weight of the person after they have fallen 2 metres.

In the fall arresting device, the tensile strength of the links is such that, for a person of a given weight, the links should be able to support that weight without tearing when the weight is static. The device may be such that successive links have an increasingly high tensile strength.

The fall arresting device of the present invention will be attached between the person operating at a height, e.g. via a harness, and a structure, e.g. a building or scaffolding. To allow the person free movement, a line may be attached either between the person and the fall arresting device or between the fall arresting device and the structure. However, to prevent the person falling too far before the fall arresting device is deployed, the line may be wound onto a spring-loaded spool that winds up any slack line and the spool could include a centrifugal clutch that locks when the line is withdrawn from the spool too quickly, i.e. when the person falls.

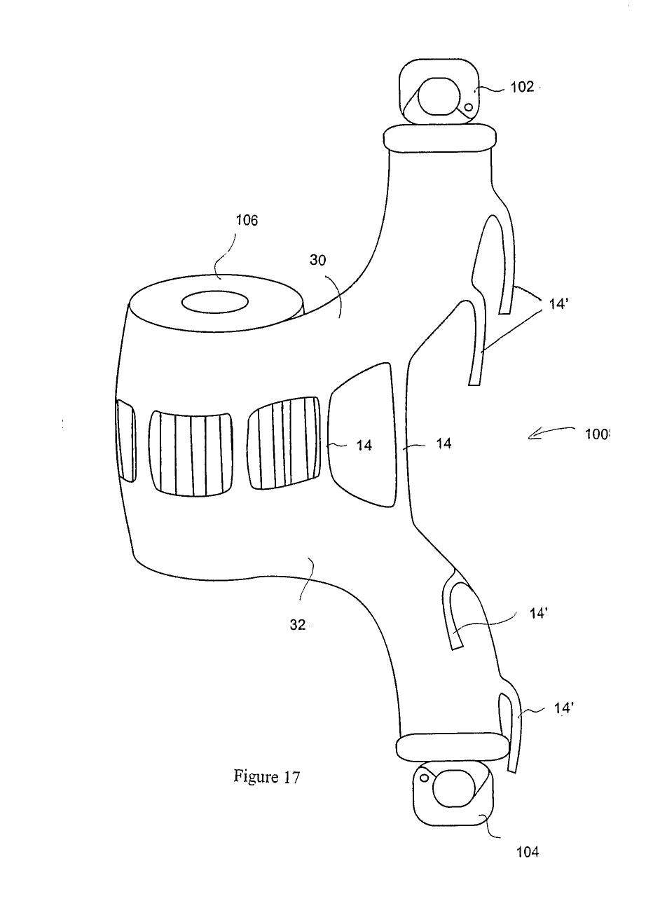

The fall arresting device could also be fed onto the spool if the device is wound up or bunched up tightly. Such an arrangement is shown in FIG. 17, where the device 100 is wound up on a reel 106. The ends of the elongate members 30,32 are provided with gated hooks 102,104; hook 102 is secured to a structure and hook 104 is secured to a person working at height, e.g. via a harness and a karabiner (not shown) The worker can tear a number of links 14′ to allow him/her to move about during the course of their work. If he/she should fall, the untorn links 14′ arrest the fall by the stretching and failing mechanism described above.

1. A device configured to lower a weight from a structure in a controlled manner, the device comprising:
a first elongate member having an anchoring end that includes means configured to attach the anchoring end to the structure;
a second elongate member extending alongside the first elongate member and having a weight-support end that includes means configured to support the weight,
a plurality of links connecting the first and the second elongate members together, the links being spaced-apart along the length of the first and the second members and being made of a ductile polymer material that can successively stretch and fail when the weight is supported by the said support end of the second member and the said anchoring end of the first elongate member is attached to the structure,
wherein the anchoring end of the first elongate member is provided at the same end of the device as the weight support end of the second elongate member.

2. A device as claimed in claim 1, wherein the first and second members are arranged parallel to each other.

3. A device as claimed in claim 1, wherein the links are made of a straight-chained unbranched polymer.

4. A device as claimed in claim 1, wherein the links are each such that they can stretch by a distance before they fail that is at least as large as that necessary to allow the next succeeding link to support at least part of the weight.

5. A device as claimed in claim 1, which includes a plurality of pairs of first and second elongate members and the said plurality of pairs of first and second elongate members are capable of lowering a single weight when supported by the second elongate member of each pair.

6. A device as claimed in claim 5, which includes an selector for selectively engaging (a) each pair of first and second elongate members when the force applied by the weight exceeds a threshold value, whereby all the pairs of first and second elongate members are configured to lower the weight, and (b) fewer than the plurality of pairs of first and second elongate members when the force applied by the weight is less than a threshold value, whereby fewer than the plurality of pairs of first and second elongate members are configured to lower the weight.

7. A device as claimed in claim 6, wherein the selector includes a yoke connecting together the second elongate members of each pair and wherein the selector has a first fracture point that is capable of fracturing relatively slowly under a relatively low force applied by the weight and a second fracture point that is capable of fracturing relatively fast when the force applied to the weight exceeds a threshold value that is higher than the force necessary to fracture the first fracture point and wherein the arrangement is such that, when the yoke is fractured at the first fracture point, the yoke is configured to lower the weight using fewer than the plurality of pairs of elongate members and, when the yoke is fractured at the second fracture point, the yoke is configured to lower the weight using the plurality of pairs of elongate members.

8. A device as claimed in claim 7, wherein the yoke is substantially as shown in FIG. 7.

9. A device as claimed in claim 1, which includes two or four pairs of first and second elongate members.

10. A device as claimed in claim 1, that is configured to break the fall of an 80 kg person over a distance not exceeding 2 metres when the device supports the weight of the person after they have fallen 2 metres.

11. A method of lowering a weight from a structure using a device as claimed in any one of claims 1 to 10, the method comprising:
attaching the anchor end of the first elongate member to the structure;
attaching the weight to the weight-support end of the second elongate member, and
allowing the weight to drop, whereby the plurality of links connecting the first and the second elongate members together successively stretch and fail, thereby lowering the weight from the structure.

12. A method as claimed in claim 11 wherein weight is a person and the step of allowing the weight to drop comprises the person falling from a height.
